(19) United States
(12) Patent Application Publication
(10) Pub. No.: US 2004/0124840 A1
(43) Pub. Date: Jul. 1, 2004

(54) Antenna arrangement and coupling method for a magnetic resonance apparatus

(76) Inventor: Arne Reykowski, Erlangen (DE)

Correspondence Address: SCHIFF HARDIN, LLP, PATENT DEPARTMENT, 6600 SEARS TOWER, CHICAGO, IL, 60606-6473, US

(21) Appl. No.: 10/668,861

(22) Filed: Sep. 23, 2003

(30) Foreign Application Priority Data
Sep. 23, 2002 (DE) 10244172.3

(51) Int. Cl. G01V 3/00

(52) U.S. Cl. 324/318; 324/307

(57) ABSTRACT

In an antenna arrangement for an magnetic resonance device and a method for acquiring magnetic resonance signals, at least two adjacent individual antennas are provided and a galvanically contact-free decoupling coil is fashioned and/or arranged such that it inductively couples with both adjacent individual antennas so that the inductive coupling is minimal between the two adjacent individual antennas.

### BACKGROUND OF THE INVENTION

1. Field of the Invention

The present invention concerns an antenna arrangement for a magnetic resonance apparatus of the type having two adjacent individual antennas, as well as a method for acquiring magnetic resonance signals with such an antenna.

2. Description of the Prior Art

In a magnetic resonance examination of specific organs or body parts of a patient, surface antennas are increasingly used to receive the nuclear magnetic resonance signals (magnetic resonance signals). These surface antennas are arranged in the examination relatively close to the surface of the body directly at the organ or body part of the patient to be examined. In contrast to larger antennas arranged farther from the patient that are normally used to generate an overall cross-section through a patient, these surface antennas have the advantage of being able to be arranged closer to the region of interest. The noise component caused by electrical losses within the body of the patient is thereby reduced, which causes the signal-to-noise ratio (SNR) of a surface antenna, in principle, to be better than that of a more remotely located antenna. A disadvantage, however, is that an individual surface antenna is only able to generate an effective image within a determined spatial region or range which lies in the order of magnitude of the diameter of the conductor loop of the surface antenna. The possibilities for use of such individual surface antennas therefore are very limited, due to the restricted region of observation. The region of observation can be expanded, by enlarging the diameter of the conductor loop of the surface antenna, but such an enlargement of the conductor loop increases the aforementioned electrical losses in the body of the patient and, as a consequence, the signals are received with an increased noise component.

Therefore, given use of an individual surface antenna, a compromise must always be made between the best possible resolution and the largest possible region of observation. A possibility to enlarge the region of observation without reducing the resolution to the same degree is to use a number of individual surface antennas, arranged adjacent to one another, which form a large surface area antenna.

A problem in the use of such an antenna arrangement with a number of adjacent individual antennas is that a high-frequency current in one individual antenna can induce a voltage in an adjacent individual antenna. This is typically characterized as inductive coupling of the antennas. This inductive coupling results in a signal generated in one of the adjacent antennas automatically also causing a signal component in the adjacent antenna. The inductive coupling consequently degrades the signal-to-noise ratio. In addition, the complexity in an evaluation of the signals from coupled individual antennas is greater than in non-coupled individual antennas. An inductive coupling of the individual antennas therefore should be avoided if possible.

A method to decouple adjacent antennas is disclosed in U.S. Pat. No. 4,825,162, for example. The decoupling is achieved by the conductor loops of adjacent antennas overlapping to a certain degree, such that overall the inductive coupling between the affected antennas is minimal. A disadvantage of such a geometric decoupling is that the development (design) of the antenna arrangement is extremely complicated, since initially a number of antenna arrangements with different geometries must be experimentally fashioned in order to find the geometry in which the coupling is minimal. Furthermore, for such a decoupling an antenna arrangement is always necessary in which every adjacent individual antenna overlaps in a suitable manner. This means antenna arrangements in which no overlaps exist at all between adjacent antennas are not feasible for this purpose.

Another possibility to decouple two adjacent antennas is disclosed in U.S. Pat. No. 5,708,361. The conductor loops of two adjacent individual antennas have an interruption (gap), the interruptions being electrically connected in parallel and each bridged with a capacitive element. The inductive voltage is compensated via this coupler capacitor. The decoupling via such a coupler capacitor, however, has the disadvantage that the two adjacent individual antennas are galvanically connected with one another.

A further possibility is to use a transmitter (repeater) that operates with the same coupler inductance but opposite polarity with regard to the two adjacent antennas, such that the coupler inductance is compensated between the antennas. Such a transmitter has the disadvantage that it is relatively difficult to construct. In addition, it normally has a relatively large overall height and is in particular therefore not suitable for a use in very flat antenna arrangements that, for example, should be applied directly on or under the patient.

### SUMMARY OF THE INVENTION

An object of the present invention is to provide an alternative to known decoupling arrangements, with which a decoupling of two adjacent individual antennas is possible in a cost-effective and simple manner.

This object is achieved in an antenna arrangement according to the invention wherein a galvanically contact-free decoupling coil is used for decoupling two adjacent individual antennas, which is fashioned and/or arranged (i.e. configured) such that it is inductively coupled with both adjacent individual antennas, so that the inductive coupling is minimal between the two appertaining individual antennas. The term “galvanically contact-free” are used herein means that the decoupling coil has no galvanic contact at all to the other components. This means that the decoupling coil is not grounded and has no connections at all to any measurement devices, amplifiers, or other antennas, but rather is only inductively coupled (“free-floating”) with the respective individual antennas.

In this decoupling method, a current is induced in the decoupling coil by the inductive coupling with both individual antennas to be decoupled, and this current is again inductively fed back to both individual antennas. The coupling of the decoupling coil to the individual antennas to be decoupled can be adjusted such that the inductive coupling between the individual antennas and the decoupling coil almost completely—in the ideal case, completely—cancels the inductive coupling between the adjacent individual antennas, such that the individual antennas are decoupled from one another.

The coupling between the decoupling coil and the individual antennas in principle can be set by a suitable coupler geometry (for example, by appropriate selection of the surface of the decoupling coil or the distance to the individual antennas) such that the inductive coupling is minimal between the adjacent individual antennas. A capacitive component and/or an inductive component, however, preferably is switched within the decoupling coil which sets the current in the decoupling coil at a predetermined value at which the inductive coupling is minimal between both individual antennas to be decoupled. In this manner, a minimization of the coupling between the individual antennas is possible without an elaborate modification of the coupler geometry. Since capacitive components normally have better performance than comparable inductors, in particular a capacitive component, for example a suitable capacitor, preferably is used.

Due to the lesser complexity, in the normal case a capacitive or inductive component with a fixed value is used in the successive production of such antenna arrangements, after the optimal value is determined in the design phase by adjustment of a variable-value component. Achieving a manufacturing quality with a high reproducibility thus is easily facilitated. It is also possible to set an adjustable component (for example, a controllable trim capacitor) in the production of each antenna arrangement. In this manner, the decoupling coil can be readjusted during operation at any time, for example via the magnetic resonance device, by changing of other parameters that influence the coupling, in order to adjust the optimal current and to minimize the coupling between the adjacent antennas to be decoupled.

In a preferred embodiment of the inventive antenna arrangement, each adjacent individual antenna has a conductor loop that is arranged primarily (substantially) in a common antenna plane. The term “antenna plane” includes configurations in which the conductor loops are arranged adjacent to or partially overlapping one another in two parallel planes abutting one another or lying a short distance from one another. The antenna plane also can conform to an arbitrary shape of an antenna housing and/or to other requirements of the surroundings, for example the body of the patient, meaning, for example, wound around a cylinder or alternatively curved. A typical example for this purpose is the assembly of the conductor loops in the shape of conductor paths in a multilayer board or in a multilayer conductor path film.

The individual antennas thereby form what is called an antenna array. In the exemplary embodiments described herein (to simplify matters) that it is assumed that the individual antennas as well as the decoupling coils each are composed of an individual conductor loop that is (as warranted) shaped in a specific manner. In as much, the terms “individual antenna” and “decoupling coil” and “conductor loop” can be used synonymously. The individual antennas and/or the decoupling coil, however, can include further components such as, for example, further conductor loops, capacitors, inductors, tuning devices, etc. The invention therefore is not limited to individual antennas or decoupling coils with only one conductor loop.

Various possibilities exist for the arrangement of the decoupling coil for decoupling such individual antennas lying primarily in an antenna plane.

In the embodiment, the decoupling coil has a conductor loop that is arranged in a plane that is primarily perpendicular to the adjacent individual antennas to be decoupled.

In another embodiment, the decoupling coil has a conductor loop that is arranged in a plane that is primarily parallel to the adjacent individual antennas to be decoupled.

In a preferred version of this second embodiment, the conductor loop of the decoupling coil wound into a Figure-eight and is arranged parallel to the individual antennas to be decoupled, such that respective loop halves of the Figure-eight at least partially overlap with the two individual antennas. Such a Figure-eight type conductor loop is also called a “double loop” decoupling coil or “butterfly” decoupling coil. This geometric shape has the advantages that it is unsusceptible to excitation from a homogenous field, and that no coupling of the transmission field ensues, since the net flow is zero in the ideal case due to the opposite symmetry of the two loop sections.

In a preferred assembly of such an antenna array, a plurality of individual antennas are arranged in rows and columns in an antenna plane, with the individual antennas that are directly adjacent in a specific row and the individual antennas directly that are adjacent in a specific column overlapping one another for decoupling. The respective diagonally (i.e. at the corner) adjacent individual antennas are, in contrast, decoupled from one another by means of a decoupling coil, for example a butterfly-decoupling coil.

The individual antennas can be considered as groups of four individual antennas, disposed in two adjacent rows and two adjacent columns. Both individual antennas that are diagonally adjacent to one another in such a group can always be decoupled by a butterfly-decoupling coil. The Figure-eight-shaped conductor loops preferably proceed with their axes of symmetry parallel to the connecting diagonals of the individual antennas to be decoupled, such that their axes of symmetry are primarily perpendicular to one another. This arrangement perpendicular to one another ensures that the decoupling coils do not disrupt one another.

### DESCRIPTION OF THE DRAWINGS

FIG. 1 is a schematic depiction of the inductive decoupling between two adjacent surface antennas.

FIG. 2 is a simplified equivalent circuit diagram for the antenna arrangement according to FIG. 1.

FIG. 3 is a schematic depiction of the inductive coupling of both antennas according to FIG. 1, with a decoupling coil according to a first exemplary embodiment of the invention.

FIG. 4 is a simplified equivalent circuit diagram for the arrangement of the antennas and the decoupling coil according to FIG. 3.

FIG. 5 is a schematic depiction of the inductive coupling of both coils according to FIG. 1, with a decoupling coil according to a second exemplary embodiment of the invention.

FIG. 6 is a simplified equivalent circuit diagram for the arrangement of the antennas and the decoupling coil according to FIG. 5.

FIG. 7 is a depiction of the geometric arrangement of an antenna array of four individual antennas, arranged next to one another in two rows and two columns, which partially overlap.

FIG. 8 is a top view of the geometric shape of a specific exemplary embodiment of the invention for a butterfly-decoupling coil.

FIG. 9 is a schematic top view of the use of a decoupling coil according to FIG. 8 to decouple two individual antennas from FIG. 7 arranged diagonally.

FIG. 10 is a top view of the antenna arrangement from FIG. 8 including the arrangement of decoupling coils according to FIG. 7 to decouple the respectively diagonal non-overlapping adjacent individual antennas.

### DESCRIPTION OF THE PREFERRED EMBODIMENTS

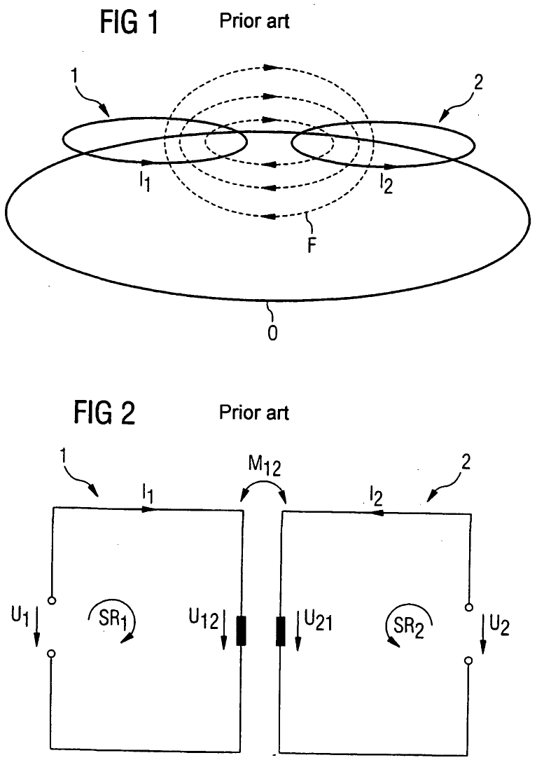

It is shown in FIG. 1 how an adjacent arrangement of two individual antennas 1, 2 leads to an inductive coupling of these antennas 1, 2. To simplify matters, it is assumed that the antennas 1, 2 are each a simple circular coil or conductor loop.

These antennas 1, 2 are thereby located at a specific distance from one another above a surface of a patient, who represents a resistive load. A magnetic field F, which also arises in the region of the conductor loop of the second antenna 2, is generated by a high-frequency current I₁ (for example caused by the reception of an magnetic resonance signal) within the conductor loop of the first antenna 1. A voltage, and thus a current, is induced in the second antenna 2 by this magnetic field F. Likewise, the antenna 2 couples a high-frequency current I₂ into the first antenna 1.

The exact relationship can be best described with reference to a simplified equivalent circuit diagram (FIG. 2) of this arrangement. Both antennas 1, 2 are shown here in rectangular form, which is, however, irrelevant for the principle involved. In addition to the currents I₁ and I₂, the current directions SR₁, SR₂ as well as the appertaining voltages U₁, U₂ are also indicated at the terminals (not shown in FIG. 1) of the antennas 1, 2. The inductive coupling between the adjacent antennas 1, 2 is schematically shown as a mutual inductance M₁₂. Due to the existing mutual inductance M₁₂, the current I₁ in the antenna 1 induces a voltage U₂₁ in the antenna 1. These induced voltages contribute to the total voltage U₁, U₂ of the respective antenna 1, 2 that respectively form the actual measurement signals at the appertaining antennas 1, 2. This means the respective voltage U₁, U₂ at the antennas 1, 2 is given by

I₁·jωL₁+U₁₂=U₁ (1a)

I₂·jωL₂+U₂₁=U₂ (1b)

L₁ and L₂ are the inductivities of the two conductor loops of the antennas 1, 2, ω is the angular frequency of the high-frequency current, i.e. the frequency of the magnetic resonance signal to be received, and j designates the imaginary number. The terms jωL₁ and jωL₂ are the “normal” impedance or reactance of the respective antenna 1, 2.

The respective additional induced voltages U₁₂ and U₂₁ ensue as follows:

U₁₂=I₂·jωM₁₂ (2a)

U₂₁=I₁·jωM₁₂ (2a)

The mutual inductance is M₁₂, which is the same in terms of magnitude in both directions, i.e. for the coupling from the first antenna 1 into the second antenna 2 and for the coupling from the second antenna 2 into the first antenna 1. The term jωM₁₂ is known as the coupling impedance between the two antennas 1, 2.

Overall, the voltages U₁, U₂ on the two antennas 1, 2 are:

I₁·jωL₁+I₂·jωM₁₂=U₁ (3a)

I₁·jωM₁₂+I₂·jωL₂=U₂ (3b)

It is clear that such a coupling whereby signals respectively received by the antennas 1, 2 simultaneously is coupled into the other adjacent antennas 2, 1, decreases the reception quality and on the other hand also leads to an increased complexity in the evaluation of the signals, and therefore should be avoided.

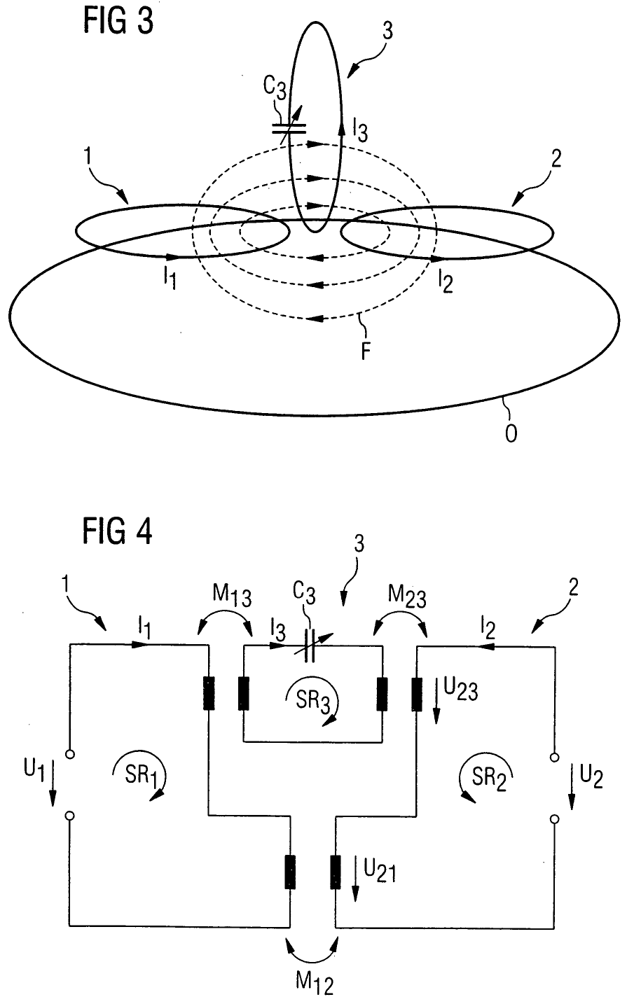

FIG. 3 shows once more an antenna arrangement with two adjacent individual antennas 1, 2 according to FIG. 1, however, here an inventive decoupling coil 3 is brought in proximity to the two antennas 1, 2. This decoupling coil 3 has no galvanic contact at all to any other antennas, ground potentials, measurement devices, etc. The decoupling coil 3 is thereby arranged barely above the antennas 1, 2 in a plane proceeding through between the antennas 1, 2 perpendicular to the plane of the antennas 1, 2.

A current I₃ is induced in the decoupling coil 3 by the currents I₁ and I₂ in the antennas 1, 2. In the shown exemplary embodiment, a capacitor C₃, here a trim capacitor, is connected in the decoupling coil 3. The magnitude and the polarity of I₃ can be set by selection of the value of the capacitor C₃.

It is shown in the following how the coupling between the two antennas 1, 2 can be minimized by a suitable selection of the capacitor C₃, and thus by appropriate setting of the induced current I₃ in the decoupling coil 3.

FIG. 4 shows a simplified equivalent circuit diagram for the previously shown arrangement. In addition to the currents I₁, I₂, I₃ in the antennas 1, 2 as well as the decoupling coil 3, FIG. 4 shows the current directions SR₁, SR₂, SR₃ and the mutual inductances M₁₂, M₁₃, M₂₃ between the two antennas 1, 2 as well as between each of the antennas 1, 2 and the decoupling coil 3.

In addition, the voltages U₁, U₂ created at the terminals of the antennas 1, 2 are indicated, as well as the voltages U₂₁, U₂₃ induced for the second antenna 2 in the first antenna 1 and in the decoupling coil 3. From this it is clear that the signal coupled from the high-frequency current I₁ of the first antenna 1 to the second antenna 2 is exactly zero when U₂₁+U₂₃=O. The corresponding is also true for the reversed coupling of the second antenna 2 to the first antenna 1.

In order to calculate the value of the current I₃ to the decoupling coil 3, the corresponding value of the capacity C₃, required to produce this combination, the mesh equations for the equivalent circuit diagram according to FIG. 4 provide a starting point:

Mesh 1:

I₁·jωL₁+I₂·jωM₁₂−I₃·jωM₁₃=U₁ (4a)

Mesh 2:

I₁·jωM₁₂+I₂·jωL₂+I₃·jωM₂₃=U₂ (4b)

$$Mesh 3 \text{:} \\ - {I}_{1} \cdot j ω {M}_{13} + {I}_{2} \cdot j ω {M}_{23} + {I}_{3} \cdot ( j ω {L}_{3} + \frac{1}{j ω {C}_{3}} ) = 0 \qquad ( 4 c )$$

By solving the equation (4c) for I₃, one obtains

$${I}_{3} = - {I}_{1} \frac{{ω}^{2} {M}_{13} {C}_{3}}{1 - {ω}^{2} {L}_{3} {C}_{3}} + {I}_{2} \frac{{ω}^{2} {M}_{23} {C}_{3}}{1 - {ω}^{2} {L}_{3} {C}_{3}} \qquad ( 5 )$$

If equation (5) is used in the equations (4a) and (4b) for the respective meshes of the first antenna 1 and the second antenna 2, one obtains:

$$\begin{matrix}{I}_{1} \cdot ( j ω {L}_{1} + j ω \frac{{ω}^{2} {M}_{13} {M}_{13} {C}_{3}}{1 - {ω}^{2} {L}_{3} {C}_{3}} ) + {I}_{2} \cdot ( j ω {M}_{12} - j ω \frac{{ω}^{2} {M}_{13} {M}_{23} {C}_{3}}{1 - {ω}^{2} {L}_{3} {C}_{3}} ) = {U}_{1} & ( 6 a ) \\ {I}_{1} \cdot ( j ω {M}_{12} - j ω \frac{{ω}^{2} {M}_{13} {M}_{23} {C}_{3}}{1 - {ω}^{2} {L}_{3} {C}_{3}} ) + {I}_{2} \cdot ( j ω {L}_{2} + j ω \frac{{ω}^{2} {M}_{23} {M}_{23} {C}_{3}}{1 - {ω}^{2} {L}_{3} {C}_{3}} ) = {U}_{2} . & ( 6 b )\end{matrix}$$

A decoupling then exists when U₁ is independent of I₂ and U₂ is independent of I₁. The respective coupler terms (i.e. the second term in equation (6a), which specifies the component of the voltage U₁ created in the first antenna 1 induced from the current I₂ in the second antenna 2) as well as the first term in equation (6b) (which specifies component of the voltage U₂ created on the second antenna 2 induced from the current I₁ in the first antenna 1) should consequently be equal to zero. This means that:

$$j ω {M}_{12} - j ω \frac{{ω}^{2} {M}_{13} {M}_{23} {C}_{3}}{1 - {ω}^{2} {L}_{3} {C}_{3}} = 0 \qquad ( 7 )$$

As soon as equation (7) is fulfilled, no coupling exists any longer between the two adjacent antennas 1, 2. Solving the equation (7) for C₃ gives:

$${C}_{3} = \frac{{M}_{12}}{{ω}^{2} ( {M}_{13} {M}_{23} + {L}_{3} {M}_{12} )} \qquad ( 8 )$$

This means, given a known inductance L₃ of the decoupling coil 3, as well as known mutual inductance M₁₂, M₁₃, M₂₃, as well as a known angular frequency ω, the value of the capacitance C₃ can be unambiguously determined, so that coupling between the adjacent antennas 1, 2 is prevented.

Since the mutual inductances M₁₂, M₁₃, M₂₃ are normally not known, and are also difficult to determine, a trim capacitor is preferably used (as is shown in FIGS. 3 and 4) that is adjusted until the minimum of the coupling between the antennas 1 and 2 is achieved. In the normal case, it is assumed that all of the parameters determining the capacitance C₃ according to equation (8) are constant for a given assembly and arrangement of the decoupling coil 3 as well as a fixed antenna geometry. A capacitor with a constant value therefore can be used insofar as the correct value of the capacitance C₃ is found once.

As is additionally shown in equation (8), it should be noted that the coupling between the decoupling coil 3 and the antennas 1, 2 is not too small. If the mutual inductances M₁₃, M₂₃ were to approach zero, the decoupling loop 3 would then be resonant and very high currents would flow therein. This problem can be easily avoided by an appropriate geometric assembly of the coupling coil 3.

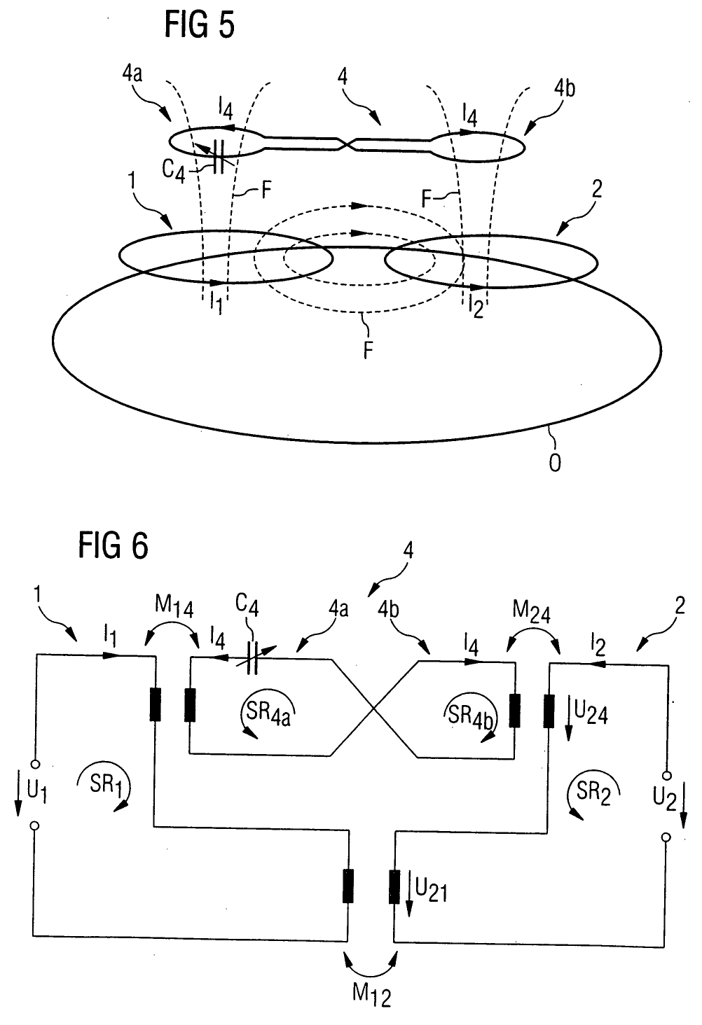

FIG. 5 shows a further exemplary embodiment of an inventive decoupling coil 4. The decoupling coil 4 here lies in a parallel plane over the plane of the two antennas 1, 2 and has a figure-eight-shaped conductor loop, with one loop half 4a located over a the first antenna 1 and a second loop half 4b located over the second antenna. Such a decoupling coil 4 is also referred to as a butterfly-decoupling coil 4. The current I₄ is respectively reversed in the two coil halves 4a, 4b.

Also with regard to this arrangement, reference is again made to the equivalent circuit diagram (FIG. 6) in which the individual couplings M₁₂, M₁₄, M₂₄ and induced voltages U₂₁, U₂₄, as well as the currents I₁, I₂, I₄ and current directions SR₁, SR₂, SR₄ₐ, SR_{4b}, are shown. The voltage induced in the antenna 2 by the voltage present in the antenna 1 is again zero when U₂₁+U₂₄=0.

The starting point of the calculations Is once again the mesh equations for the equivalent circuit diagram (FIG. 6):

Mesh 1:

I₁·jωL₁+I₂·jωM₁₂+I₄·jωM₁₄=U₁ (9a)

Mesh 2:

I₁·jωM₁₂+I₂·jωL₂+I₄·jωM₂₄=U₂ (9b)

$$Mesh 3 \text{:} \\ {I}_{1} \cdot j ω {M}_{14} + {I}_{2} \cdot j ω {M}_{24} + {I}_{4} \cdot ( j ω {L}_{4} + \frac{1}{j ω {C}_{4}} ) = 0 \qquad ( 9 c )$$

From the mesh equation (9c) for the decoupling coil 4 again results

$${I}_{4} = {I}_{1} \frac{{ω}^{2} {M}_{14} {C}_{4}}{1 - {ω}^{2} {L}_{4} {C}_{4}} + {I}_{2} \frac{{ω}^{2} {M}_{24} {C}_{4}}{1 - {ω}^{2} {L}_{4} {C}_{4}} \qquad ( 10 )$$

If equation (10) is used in the in the equations (9a) and (9b), one obtains:

$$\begin{matrix}{I}_{1} \cdot ( j ω {L}_{1} - j ω \frac{{ω}^{2} {M}_{14} {M}_{14} {C}_{4}}{1 - {ω}^{2} {L}_{4} {C}_{4}} ) + {I}_{2} \cdot ( j ω {M}_{12} - j ω \frac{{ω}^{2} {M}_{14} {M}_{24} {C}_{4}}{1 - {ω}^{2} {L}_{4} {C}_{4}} ) = {U}_{1} & ( 11 a ) \\ {I}_{1} \cdot ( j ω {M}_{12} - j ω \frac{{ω}^{2} {M}_{14} {M}_{24} {C}_{4}}{1 - {ω}^{2} {L}_{4} {C}_{4}} ) + {I}_{2} \cdot ( j ω {L}_{2} - j ω \frac{{ω}^{2} {M}_{24} {M}_{24} {C}_{4}}{1 - {ω}^{2} {L}_{4} {C}_{4}} ) = {U}_{2} & ( 11 b )\end{matrix}$$

If it is again stipulated that the respective coupler term (i.e. the second terms in equation (11a) and the first term in equation (11b) are equal to zero, then from this requirement one subsequently obtains the capacitance necessary for the decoupling:

$${C}_{4} = \frac{{M}_{12}}{{ω}^{2} ( {M}_{12} {L}_{4} - {M}_{14} {M}_{24} )} \qquad ( 12 )$$

Also, given such a butterfly decoupling coil 5, a complete decoupling of the adjacent antennas 1, 2 is consequently possible in the ideal case by the selection of the value of the capacitor C₄.

However, it should be noted that the required value of the capacitance C₄ can also be negative, due to the minus sign in the denominator of the equation (12). An inductive component would then have to be used, or the capacitance C₄ would have to be exchanged with a suitable coil. However, since inductances have lower quality than comparable capacitors, a capacitor preferably is used and implemented between the decoupling coil 4 and the antennas 1, 2 instead of an inductance, such that a negative polarity is avoided. It must only be insured that the mutual inductances M₁₄ and M₂₄ are not too large, i.e. the distance between the decoupling coil 4 and the antennas 1, 2 to be decoupled may not be too close. Another alternative to avoid a negative polarity is to increase the inductance L₄ of the decoupling coil 4.

The use of a butterfly-decoupling coil 4 has a number of advantages. Such a decoupling coil 4 is unreceptive with regard to excitations from a homogenous field of the magnetic resonance device, since the net flow is equal to zero due to the opposition of the two partial loops 4a, 4b. This also ensures that the transmission field is not coupled with the decoupling coil 4. Such a coupling of the transmission field would otherwise lead to a local field increase and this to a warming of specific regions in the patient. The so-called SAR (Specific Absorption Ratio) would be locally increased and predetermined limit values possibly would be exceeded. Given the use of a butterfly-decoupling coil 4, no further measures at all are necessary in order to prevent such a coupling of the field, meaning, for example, that it is not necessary to detune decoupling loops during the transmission phase.

In this context, it should be noted that the value of the capacitive element in each of the inventive decoupling coils 3, 4 is implemented such that the induced current I₃, I₄ for decoupling the adjacent antennas 1, 2 is optimal. This implies simultaneously that (different than with the antennas 1, 2 themselves, which likewise can be provided with adjustable capacitors) no regulation of the self-resonance ensues on the magnetic resonance frequency. The inventive decoupling coils 3, 4 are also for this reason transparent for the transmission field and do not need to be explicitly detuned in the transmission phase.

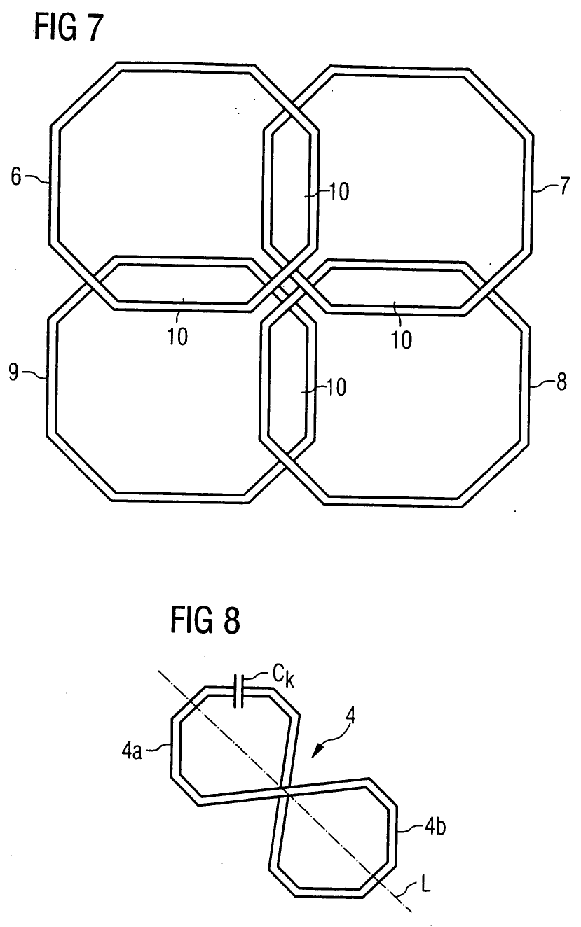

FIGS. 7 through 9 respectively show various individual components or partial superstructures of a complete antenna arrangement according to FIG. 10. A field of four individual antennas 6, 7, 8, 9 arranged next to one another in two rows and two columns form an octagonal conductor loop.

FIG. 7 shows the arrangement of the antennas 6, 7, 8, 9 from above, whereby the shape and the position of the conductor loops of the antennas 6, 7, 8, 9 are only roughly shown. In the conductor loops, capacitors to tune the individual antennas 6, 7, 8, 9 to resonance with the magnetic resonance signal are not shown nor are the connections to sense the received magnetic resonance signals.

A decoupling of two antennas 6, 7, 8, 9 lying next to one another in a column or in a row ensues here in a classical manner by means of an overlap of the adjacent conductor loops, the overlap region 10 being large, such that the coupling is minimal between the appertaining antennas 6, 7, 8, 9.

The octagonal shape has the advantage that the conductor loops at the overlap cross at right angles, and therefore the conductor paths of different antennas do not proceed parallel close to one another. In addition, it is ensured by this arrangement that in an overlap region 10 only two of the adjacent conductor loops 6, 7, 8, 9 overlap. The octagonal shape in addition has the advantage that herewith the ideal circular form of antenna is approximately achieved, i.e. here the ratio between enclosed surfaces and the length of the conductor loop is relatively large. A higher degree of efficiency is thus achieved.

A disadvantage of this arrangement is that no decoupling occurs between diagonally adjacent antennas (i.e., for example, between the antenna 6 in the upper left and the antenna 8 in the lower left, as well as between the antenna 7 in the upper right and the antenna 9 in the lower left). These antennas 6, 7, 8, 9 adjacent to one another also couple inductively into one another.

In order to decouple these antennas 6, 7, 8, 9 diagonally adjacent from one another, an inventive butterfly-decoupling coil 4 (as shown in FIG. 8) can be used. The decoupling coil 4 is provided with a fixed capacitance C_{K}, i.e. a capacitor of constant value. The value of this capacitor is determined in the development (design) of the geometry by using in the development phase, an adjustable capacitor instead of a constant capacitance C_{K}. The adjustable capacitor is adjusted until the suitable value is found at which the coupling of the desired adjacent antennas 6, 7, 8, 9 is minimal. Given correspondingly high production quality with sufficient reproducibility of the coil geometries and the inductances of the individual conductor loops within the production series, a capacitance C_{K} with a constant value can then be implemented without further difficulty in the actual production. This is uncomplicated as well as more cost-effective on the other.

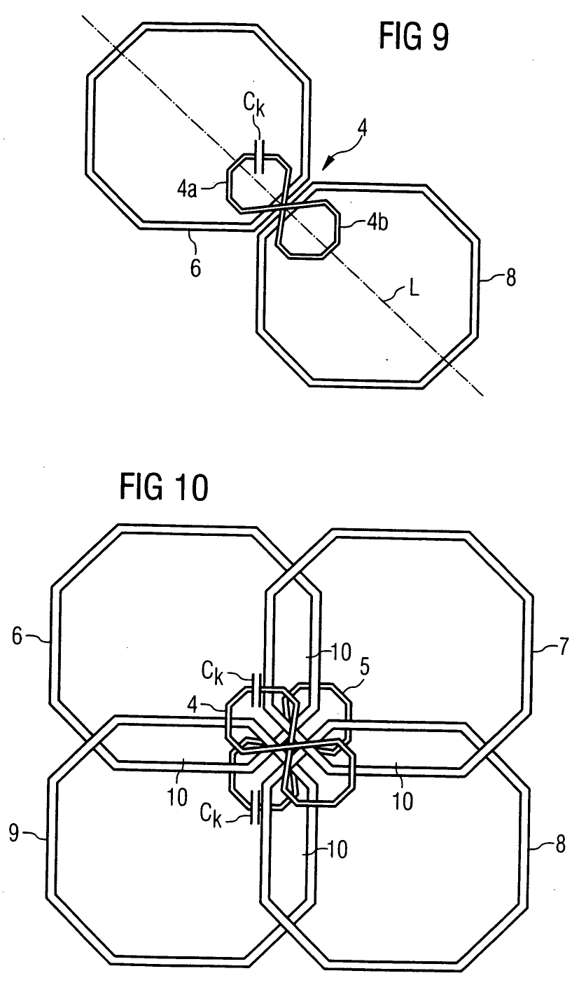

The arrangement of the decoupling coil 4 over two antennas 6, 8 diagonally adjacent to one another is separately shown in FIG. 9. Due to the decoupling of the diagonally adjacent antennas 6, 8 by means of an inventive decoupling coil 4, it is not necessary to shape the diagonally adjacent antennas 6, 8 such that an overlap is achieved for decoupling. This means a deviation from the otherwise ideal octagonal shape of the antennas 6, 7, 8, 9 is not necessary.

FIG. 10 shows the complete antenna assembly according to FIG. 7 including the position of the decoupling coils 4, 5. In FIG. 10, the respective antennas 6, 7, 8, 9 lying respectively opposite one another are each decoupled by a decoupling coil 4, 5. The decoupling coil 5 is thereby identical to the decoupling coil 4. It is arranged turned by 90°. The two decoupling coils 4, 5 are arranged to proceed with their long axes of symmetry L parallel to the respective diagonal connection lines between the antennas to be decoupled. Due to this arrangement of the decoupling coils 4, 5 at right angles to one another, the decoupling coils 4, 5 do not disturb one another.

The arrangement of the decoupling coils 4, 5 with reference to the antenna plane (in which the antennas 6, 7, 8, 9 are arranged, for example as conductor paths on a multilayer conductor path film) is such that one of the decoupling coils 5 is located (from the direction of the view in FIG. 10) beneath the antenna plane, and the other decoupling coil 4 is located above the antenna plane.

The antenna arrangement according to FIG. 10 can be arbitrarily expanded still further in the same manner in each direction, in that further antennas are appended, and the antennas that are diagonal to one another are again decoupled from one another by the inventive decoupling coils 4, 5. An arbitrarily large antenna array can thus be assembled.

At this point, it should again be noted that the configurations described above are only exemplary embodiments, and that the basic principle of the decoupling with an inventive decoupling coil can be varied in further ways by those skilled in the art.

In particular, an adjustment of the coupling between the decoupling coil and the antennas to be decoupled alternatively can ensue by modifying the coupling geometry, i.e. for example by an enlargement or downsizing of the decoupling coil, or by a closer or farther arrangement of the antennas to be decoupled. However, the use of a capacitor to determine the current on the decoupling coil is preferred, since this element allows a rapid change in size without large effort, and this a complicated experimental determination of the optimal coupler geometry is not necessary.

The inventive decoupling arrangement and method can be advantageously used to decouple surface coils. Moreover, they can be used in principle to decouple coils farther removed from one another in magnetic resonance installations.

Although modifications and changes may be suggested by those skilled in the art, it is the intention of the inventor to embody within the patent warranted hereon all changes and modifications as reasonably and properly come within the scope of his contribution to the art.

I claim as my invention:

1. An antenna arrangement for a magnetic resonance apparatus comprising:
at least two adjacent individual antennas; and
a galvanically contact-free decoupling coil configured to inductively couple with both of said adjacent individual antennas to produce a minimal inductive coupling between said two adjacent individual antennas.

2. An antenna arrangement as claimed in claim 1 comprising a reactive component, selected from the group consisting of capacitive components and inductive components, connected in said decoupling coil to set a current in said decoupling coil to a value at which said inductive coupling between said two adjacent individual antennas is minimal.

3. An antenna arrangement as claimed in claim 2 wherein said reactive component has a variable reactance.

4. An antenna arrangement as claimed in claim 1 wherein each of said adjacent individual antennas comprises a conductor loop, the respective conductor loops of said adjacent individual antennas being disposed to generate an antenna field in a common antenna plane.

5. An antenna arrangement as claimed in claim 1 wherein said decoupling coil comprises a conductor loop disposed in a plane substantially perpendicular to said adjacent individual antennas.

6. An antenna arrangement as claimed in claim 1 wherein said decoupling coil comprises a conductor loop disposed in a plane substantially parallel to said adjacent individual antennas.

7. An antenna arrangement as claimed in claim 6 wherein said decoupling coil comprises a conductor loop in a figure-eight shape, said figure-eight shape having a first loop half at least partially overlapping one of said adjacent individual antennas and a second loop half at least partially overlapping the other of said adjacent individual antennas.

8. An antenna arrangement as claimed in claim 1 comprising a plurality of adjacent individual antennas respectively disposed in rows and columns and forming a plurality of antenna groups, each antenna group containing two individual antennas directly adjacent to each other in a row, that overlap each other for decoupling, and two individual antennas directly adjacent to each other in a column, that overlap each other for decoupling, with diagonally adjacent individual antennas in each group being decoupled from each other by a decoupling coil configured so that inductive coupling between said diagonally adjacent individual antennas is minimal.

9. An antenna arrangement as claimed in claim 8 wherein the decoupling coil in each group comprises a conductor loop with a figure-eight shape having an axis of symmetry parallel to a diagonal line between said diagonally adjacent individual antennas.

10. An antenna arrangement as claimed in claim 9 wherein said conductor loop with a figure-eight shape has a first loop half overlapping one of said diagonally adjacent individual antennas, and a second loop half overlapping the other of said diagonally adjacent individual antennas.

11. An antenna arrangement as claimed in claim 10 wherein said individual antennas in each group form an octagonal conductor loop.

12. A method for acquiring magnetic resonance signals with an antenna arrangement having two adjacent individual antennas, comprising the steps of:
providing a decoupling coil in galvanically contact-free relationship to said adjacent individual antennas; and
configuring said decoupling coil to be inductively coupled with both of said adjacent individual antennas to produce a minimal inductive coupling between said two adjacent individual antennas.

13. A method as claimed in claim 12 comprising setting a current in said decoupling coil to a value at which said inductive coupling is minimal between said individual antennas by connecting a reactive component, selected from the group consisting of capacitive components and inductive components, in said decoupling coil.
